(19) United States
(12) Patent Application Publication
(10) Pub. No.: US 2009/0021377 A1
(43) Pub. Date: Jan. 22, 2009

(54) Tamperproof tag

(75) Inventor: Anu Launiainen, Pirkkala (FI)

Correspondence Address: VENABLE LLP, P.O. BOX 34385, WASHINGTON, DC, 20043-9998, US

(73) Assignee: UPM Raflatac Oy, Tampere (FI)

(21) Appl. No.: 11/907,900

(22) Filed: Oct. 18, 2007

Related U.S. Application Data
(60) Provisional application No. 60/852,659, filed on Oct. 19, 2006.

(51) Int. Cl. G08B 13/14

(52) U.S. Cl. 340/572.1

(57) ABSTRACT

A tag including a substrate bordered by an outer edge and an inner circular edge. The substrate has a face side and a reverse side. An arrangement includes an antenna and an integrated circuit on a chip on the reverse side of the substrate. The integrated circuit on the chip is electrically connected to the antenna. An adhesive on the reverse side of the substrate covers the arrangement. A part of the arrangement has a greater adhesion to the adhesive than to the substrate. First cuts extend radially from the inner circular edge. Second cuts extend parallel to the first cuts from the outer edge. A region without cuts between the first cuts and the second cuts.

### CROSS-REFERENCE TO RELATED APPLICATIONS

This application claims priority to U.S. provisional patent application 60/852,659 filed 19 Oct. 2006.

### FIELD OF THE INVENTION

The present invention relates to a tag. The tag can be used with a data carrier, such as a compact disc (CD) or a digital versatile disc (DVD), or the tag can serve as a seal in consumer packages, such as cosmetic packages, drug packages, or food packages. Examples of food packages include seals for bottles.

The aim of the invention is to provide a tamperproof tag. For example, when a data carrier is borrowed or rented, it is nowadays usually done by self-service. It is thus important that the data carriers are automatically and reliably traced, and it is essential that the tags do not remain active after they have been removed from the initial surface.

### BACKGROUND OF THE INVENTION

In the consumer packages the tag is used as a seal. The seal ensures that a consumer knows if the package has been opened before purchasing.

Usually, the tags are manufactured by arranging them in the form of a web. The web comprises sequential tags on a release web, such as a paper web provided with a release surface against the tag.

### SUMMARY OF THE INVENTION

The tag comprises a substrate which has a face side and a reverse side. On the reverse side of the substrate there is a transponder which comprises an antenna and an integrated circuit on a chip. The electrically operating RFID circuit of the transponder is an electric oscillating circuit (RCL circuit) operating at a determined frequency. The antenna can be a coil, an antenna based on the dipole antenna technique, or any other planar antenna technique. The antenna is preferably a coil antenna when it is used for data carriers. The antenna and the chip are electrically connected to each other, i.e. the chip may be electrically or capacitively connected to the antenna, and it can be attached to the antenna either directly or via a module which comprises the chip and the required electrical contacts. The transponder operates at UHF or HF frequencies.

The substrate may consist of a plastic material, such as polyesters and it may be transparent, or opaque. The antenna is formed on the reverse side of the substrate for example by etching, printing, electrolysis, plating, or by some other additive techniques, or by combining the above-mentioned techniques. The antenna is preferably made of aluminum, copper, silver, or a conductive polymeric material. For example, the antenna may comprise etched coil windings and a printed conductive bridge. The coil windings may be made of copper and the conductive bridge of silver.

The reverse side of the substrate, the antenna and the chip are covered with adhesive which possesses a strong adhesion to its counter surface. The counter surface is any surface on which the tag is intended to be attached. The adhesive is protected by a removable release sheet, such as a release paper.

The different parts of the coil antenna and/or the chip may have different adhesion forces by which they adhere to the substrate. When the adhesion to the substrate is weaker than to the adhesive, that part of the antenna and/or the chip is removed from the substrate, thus destroying the transponder. For example, the coil antenna may comprise etched copper windings and a conductive bridge which is printed with a silver paste. When one tries to remove the transponder, the printed part remains stuck to the adhesive but the copper windings come off with the substrate. Thus, the transponder is broken. It is also possible that the chip is attached so weakly to the antenna that it is removed with the adhesive. In other words, the adhesive adheres aggressively to its counter surface, such as a data carrier or a consumer package, so that the adhesive remains on the counter surface, and the parts of the antenna and/or the chip which have been stuck to the adhesive, also remain on the surface of the counter surface.

The face side of the substrate may remain as the outer surface of the tag, or extra layers may be attached to the face side. The extra layer or layers may be attached to the face side by adhesive. If there is more than one extra layer, these may be attached to each other adhesively, or they are heat-sealable to each other. Usually the only extra layer or the outermost layer of the extra layers is a printing substrate. The printing substrate may consist of paper, or printable plastic. The printing substrate may be printable with TTR (thermal transfer ribbon), flexo, or offset.

The shape of the tag is preferably annular for the use with the data carriers. The tag comprises concentrically an inner circular edge and an outer circular edge which border the annular tag. However, it is possible that the outer edge has a shape which is different from circular, for example a rectangular outer edge is possible. It is also possible that the inner edge is different from circular. It may be for example rectangular or polygonal.

In order to make it impossible to remove the tag as a whole, the tag may comprise cuts which extend through the tag in the depth direction. When one tries to remove the tag, only one piece at a time is separated from its counter surface. Therefore, there is no the possibility of the tag remaining active after it has been removed.

The cuts may be first radial cuts which extend from the inner circular edge towards the outer edge and second radial cuts which extend from the outer edge towards the inner circular edge. Between the first radial cuts and the second radial cuts there is an annular region without any cuts. The antenna, preferably a coil antenna, is located on the reverse face of the tag in that annular region so therefore that region shall be solid without any cuts. The cuts are preferably made by punching. The number of the radial cuts may vary as desired. The shape of the cuts is preferably linear, but also other shapes are possible. The cuts can also extend, for example, as radial waves.

The term “extends radially” means that the center point of the radius is the center point of the tag, or it is the center point of the concentric inner and outer edges.

In addition to the data carriers, the tag can be used in consumer packages. The cross-sectional structure of the tag for the consumer packages may be the same as the structure of the tag for the data carriers. However, the shape of the tag may be different, depending on the intended use. The annular tag may also be used for example in cosmetic packages as such or so that its center hole is omitted. A tag for sealing a package may also be, for example, square or a rectangular. A seal for bottles may be even ribbon-like.

### BRIEF DESCRIPTION OF THE DRAWINGS

In the following, the invention will be described in detail by referring to figures in which

FIG. 1 shows a view of the face side of a tag from above,

FIG. 2 shows a cross-sectional view of the tag of FIG. 1,

FIG. 3 shows a view of the face side of another tag from above,

FIG. 4 shows a view of the face side of another tag from above,

FIG. 5 shows a view of the face side of another tag from above,

FIG. 6 shows a view of a web comprising sequential tags,

FIG. 7 shows a view of the reverse side of a tag from above,

FIG. 8 shows a view of the face side of a tag for sealing a consumer package, such as a bottle, from above, and

FIG. 9 shows a view of the reverse side of the tag of FIG. 8 from above.

### DETAILED DESCRIPTION OF EMBODIMENTS OF THE INVENTION

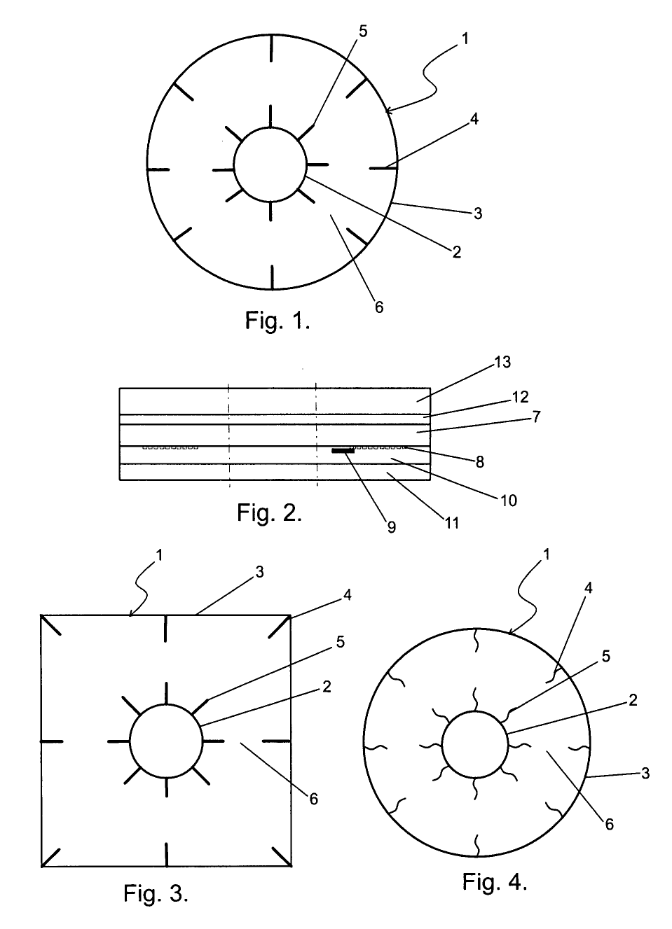

FIG. 1 shows a view of the face side of a tag 1. The tag 1 comprises an inner circular edge 2 and an outer circular edge 3 which border the annular tag 1. Radial cuts 4 extend from the outer circular edge 3 towards the inner circular edge 2, and radial cuts 5 extend from the inner circular edge 2 towards the outer circular edge 3. Between the radial cuts 4 and the radial cuts 5 there is an annular region 6 without any cuts. On the reverse side of the tag 1 in the annular region 6 there is a coil antenna (not shown), and that is why any cuts do not extend to that region 6. The cuts 4, 5 extend through the tag 1 in the depth direction. The cuts 4, 5 are preferably made by punching.

FIG. 2 shows a cross-sectional view of the tag of FIG. 1. The tag 1 comprises a substrate 7 which has a face side and a reverse side. On the reverse side there is a coil antenna comprising windings 8 which circulate around the inner circular edge 2. An integrated circuit on a chip 9 is electrically connected to the coil antenna. Adhesive 10 has been applied over the reverse side of the substrate 7, the coil antenna and the chip 9, adhering firmly to its counter surface. Suitable adhesives include, for example, acrylic adhesives and rubber based adhesives. Suitable commercial adhesives are for example 300LSE by 3M; IB1190, IB1182 and IB2180 by MacTac; L1 972 and A1208 by Collano; 9128 and 9186 by Paramelt; 1409 and 1546 by Beardow Adams; and 2422 and 2236 by Planatol.

The different parts of the coil antenna and/or the chip may have different adhesion forces by which they adhere to the substrate 7. When the adhesion to the substrate 7 is weaker than to the adhesive, that part of the antenna and/or the chip is removed from the substrate, thus destroying the transponder. For example, the coil antenna may comprise etched copper windings and a conductive bridge which is printed with a silver paste. When one tries to remove the transponder, the printed part remains stuck to the adhesive but the copper windings come off with the substrate 7. Thus, the transponder is broken. It is also possible that the chip 9 is attached to the antenna so weakly that it is removed with the adhesive.

Underneath the adhesive layer 10 there is a release sheet 11 which is removed when the tag 1 is attached to its counter surface, such as a CD or DVD. The release sheet 11 may be a release paper provided with a release surface which is against the adhesive layer 10. The cuts 4,5 do not extend through the release sheet 11.

On the face side of the substrate 7, an adhesive layer 12 may be provided, which joins the substrate 7 to a printing substrate 13. It is also possible that on the substrate 7 there are more than one layer.

FIG. 3 shows a tag which is similar to the tag shown in FIG. 1 except that the outer edge 3 is rectangular.

FIG. 4 shows a tag which is similar to the tag shown in FIG. 1 except that the first radial cuts 5 and the second radial cuts 4 are wavy. However, their advancing direction is the radial direction.

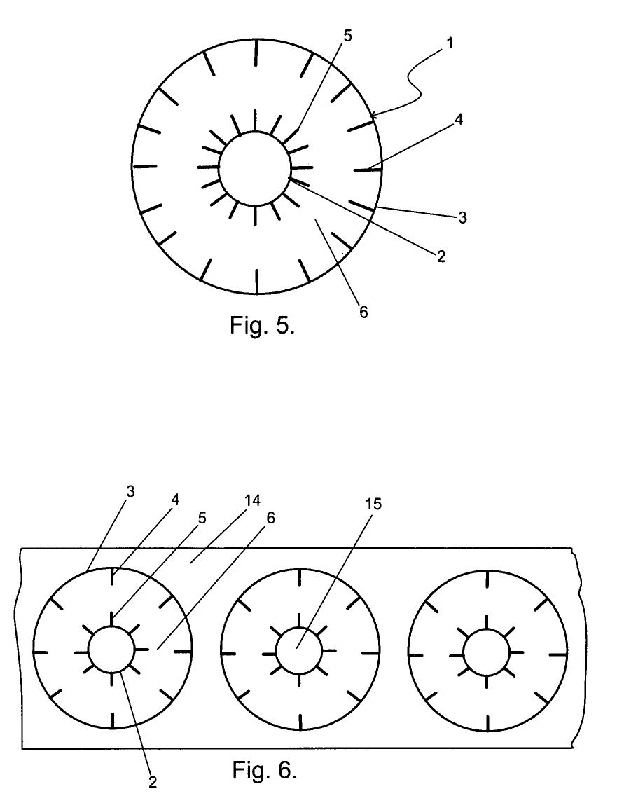

FIG. 5 shows a tag which is similar to the tag shown in FIG. 1 except that there are more cuts 4, 5.

A skilled person will readily understand that the features shown in FIGS. 1, 3, 4 and 5 are interchangeable.

FIG. 6 shows a web 14 comprising sequential tags 1. The web 14 is a release web provided with a release surface which comes against the tags 1. In the center hole 15 there may be material of the tag, or the material may be removed so that the web 14 is seen.

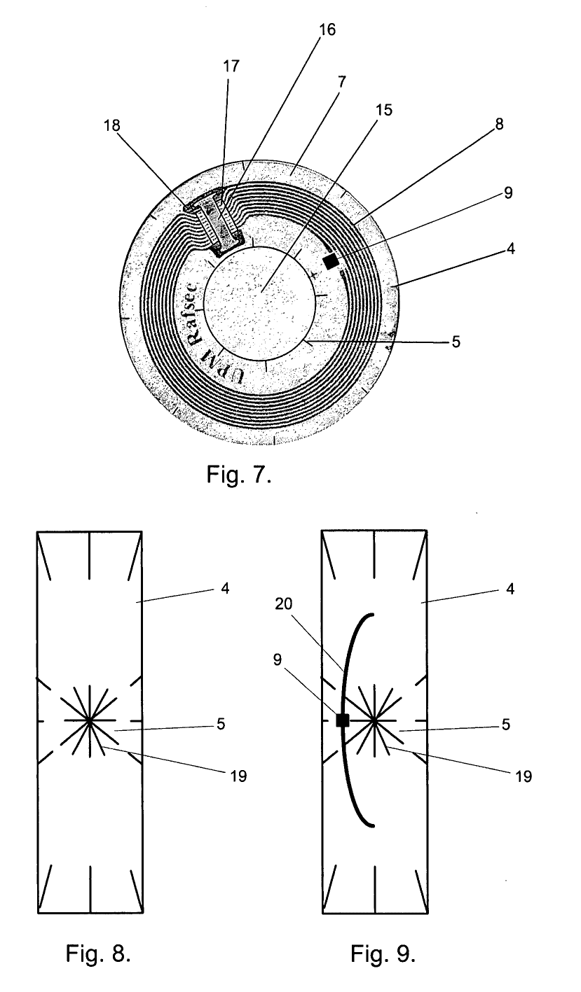

FIG. 7 shows a view of the reverse side of the tag 1 of FIG. 1. On the surface of the substrate 7 there is an antenna coil comprising windings 8. An integrated circuit on a chip 9 is electrically connected to the antenna coil. Number 16 denotes to a conductive bridge. Underneath the conductive bridge 16 there is a dielectric 17 which prevent short-circuiting. The conductive bridge 16 and the dielectric may be manufactured by printing. Number 18 denotes to the areas at the ends of the coil which are connected with the conductive bridge 16. The first radial cuts 5 and the second radial cuts 4 are straight cuts which extend radially so that there is space for the antenna coil. The bridge structure can also be a crimped bridge, or a module type of a bridge.

FIG. 8 shows a view of the face side of a tag. The tag is intended to be used as a seal in a consumer package, such as a bottle. The cross-sectional structure of the tag may be as shown in FIG. 2, i.e. the tag comprises the same layers and functional parts. The tag comprises on its reverse side an antenna and an integrated circuit on a chip. The antenna may be a coil antenna or a dipole antenna or an antenna based on some other planar antenna technique. The upper part of the tag may be attached to the bottle cap and the lower part may be attached to the bottle neck. When one tries to remove the tag and open the bottle, the tag is torn apart due to the first radial cuts 5 and second radial cuts 4. The shape of the radial cuts may vary as is illustrated in FIGS. 1, 3, 4 and 5. The tag is also provided with adhesive having a high adhesion strength so that a part of the antenna and/or the chip adheres to the adhesive when the tag is removed from its counter surface.

FIG. 9 shows a view of the reverse side of the tag of FIG. 8. On the reverse side of the tag there is an antenna 20 and an integrated circuit on a chip 9. This type of an antenna shown in FIG. 9 does not comprise any conductive bridge; Consequently, the chip 9 is usually removed with the adhesive.

A skilled person will readily understand that the tags shown in FIGS. 1 to 7 are equally usable in the consumer packages. However, it is possible that the center hole 15 does not exist but there are first radial cuts 5 so that they form a star (see FIG. 8, the star is denoted by the number 19) whose center is the mid-point of the tag.

FIGS. 1 to 9 show that the center point of the cuts is the mid-point of the tag. However, in certain cases it is possible that the center of the cuts is not the mid-point of the tag but some other point around which the radial cuts are formed.

1. A tag comprising:
a substrate bordered by an outer edge and an inner circular edge, the substrate having a face side and a reverse side,
an arrangement comprising an antenna and an integrated circuit on a chip on the reverse side of the substrate, the integrated circuit on the chip being electrically connected to the antenna,
an adhesive applied to the reverse side of the substrate so that it covers the arrangement, a part of the arrangement having a greater adhesion to the adhesive than to the substrate,
first cuts extending radially from the inner circular edge,
second cuts extending parallel to the first cuts from the outer edge, and
a region without cuts between the first cuts and the second cuts.

2. The tag of claim 1, wherein the outer edge is circular.

3. The tag of claim 1, wherein on top of the substrate there is at least one material layer attached to the substrate.

4. The tag of claim 3, wherein the material layer is a printing substrate.

5. The tag of claim 4, wherein the printing substrate consists of paper.

6. The tag of claim 1, wherein the antenna is a coil antenna which is located between the outer edge and the inner circular edge so that windings of the antenna circulate around the inner circular edge.

7. A tag comprising
a substrate bordered by an outer edge, the substrate having a mid-point, a face side and a reverse side,
an arrangement comprising an antenna and an integrated circuit on a chip on the reverse side of the substrate, the integrated circuit on the chip being electrically connected to the antenna,
an adhesive applied to the reverse side of the substrate so that it covers the arrangement, a part of the arrangement having a greater adhesion to the adhesive than to the substrate,
first cuts extending radially from the mid-point of the tag,
second cuts extending parallel to the first cuts from the outer edge, and
a region without cuts between the first cuts and the second cuts.

8. The tag of claim 7, wherein the outer edge is circular, square or rectangular.

9. The tag of claim 7, wherein on top of the substrate there is at least one material layer attached to the substrate.

10. The tag of claim 9, wherein the material layer is a printing substrate.

11. The tag of claim 10, wherein the printing substrate consists of paper.

12. The tag of claim 7, wherein the antenna is located in a region between the first cuts and the second cuts.
